(19) United States
(12) Patent Application Publication
(10) Pub. No.: US 2024/0282987 A1
(43) Pub. Date: Aug. 22, 2024

(54) System for Generating Electricity and Hydrogen

(71) Applicants: SK Innovation Co., Ltd., Seoul (KR); SK Energy Co., Ltd., Seoul (KR)

(72) Inventors: Young Dae Kim, Daejeon (KR); Chang Kuk Kim, Daejeon (KR); Ki Yeon Jeon, Daejeon (KR); Jae Suk Choi, Daejeon (KR); Seung Tae Ryu, Seoul (KR); Yeo Min Yoon, Seoul (KR)

(21) Appl. No.: 18/426,538

(22) Filed: Jan. 30, 2024

(30) Foreign Application Priority Data
Feb. 3, 2023 (KR) 10-2023-0015043

(51) Int. Cl. H01M 8/04111; H01M 8/04291; H01M 8/0432; H01M 8/04492

(52) U.S. Cl. CPC H01M 8/04111; H01M 8/04291; H01M 8/04373; H01M 8/04492

(57) ABSTRACT

A system for generating electricity and hydrogen is provided. The system includes a fuel cell unit, a liquid-gas separation unit, and a hydrogen separation unit. The fuel cell unit generates electricity and produces a fuel cell unit effluent stream containing hydrogen from a feed containing natural gas and water. The fuel cell unit includes a reformer, and the reformer includes a burner. The liquid-gas separation unit separates the fuel cell unit effluent stream into a liquid stream and a gas stream. The hydrogen separation unit separates the gas stream into a hydrogen stream and an off-gas stream. At least a portion of the off-gas stream is transferred to the burner of the reformer. The system can generate electricity and high purity hydrogen.

### CROSS REFERENCE TO RELATED APPLICATION

This application claims priority to Korean Patent Application No. 10-2023-0015043, filed Feb. 3, 2023, the disclosure of which is hereby incorporated by reference in its entirety.

### BACKGROUND OF THE INVENTION

### 1. Field of the Invention

The present disclosure relates to a system for generating electricity and hydrogen.

### 2. Description of Related Art

With the emergence of the issue of environmental pollution of exhaust from the combustion of fossil fuels, research and development of various alternative fuels has been actively carried out. Among the alternatives, research and development has been focused on hydrogen fuel and electricity. As a result, fuel cell vehicles powered by hydrogen are rapidly spreading, and the nationwide installation of hydrogen refueling stations for fuel cell vehicles is being prepared according to the spread of fuel cell vehicles.

There are two types of hydrogen refueling stations: off-site hydrogen refueling stations which are supplied with hydrogen by pipelines or tube trailers, the hydrogen being produced by a remote hydrogen production facility; and on-site hydrogen refueling stations equipped with a hydrogen production system that directly produces hydrogen on site. The on-site approach is advantageous in terms of reliability and economics because the transportation and transfer stages of the produced hydrogen are not necessary.

In addition to these types of hydrogen refueling stations, the design of hydrogen refueling stations equipped with electricity-generating fuel cells is also being studied. It is expected that hydrogen can be produced by refining the gas emitted by the fuel cells while the fuel cells generate electricity. However, reportedly, this design is still in the research stage and is not yet in the practical stage.

### DOCUMENT OF RELATED ART

### Patent Document

(Patent reference 1) U.S. Patent Application Publication No. 2004/0146760

### SUMMARY OF THE INVENTION

The present disclosure is to provide a system for generating electricity and hydrogen.

In some embodiments, there is provided a system for generating electricity and hydrogen, the system comprising: a fuel cell unit generating electricity and a fuel cell unit effluent stream comprising hydrogen from a feed comprising natural gas and water, the fuel cell unit comprising a reformer comprising a burner, a liquid-gas separation unit separating the fuel cell unit effluent stream into a liquid stream and a gas stream; and a hydrogen separation unit separating the gas stream into a hydrogen stream and an off-gas stream, in which at least a portion of the off-gas stream is transferred into the burner of the reformer.

According to some embodiments, the burner of the reformer may comprise an auxiliary fuel inlet through which an auxiliary fuel stream is supplied.

According to some embodiments, the liquid-gas separation unit may comprise an external stream inlet through which a hydrogen-containing stream externally supplied is introduced.

According to some embodiments, the system further comprises: a sensing unit detecting a water level in the liquid-gas separation unit; and a control unit performing control such that the water level detected by the sensing unit is maintained at a reference level. Based on the water level detected by the sensing unit, the control unit may perform a first operation of controlling an amount of water used as the feed, a second operation of checking whether the reformer is operating normally, a third operation of checking whether the fuel cell is operating normally, or at least two of the first through third operations.

According to some embodiments, based on a signal output from the sensing unit, the signal indicating the water level or a rate of change of the water level in the liquid-gas separation unit, and on a yield of the hydrogen stream in the hydrogen separation unit, the control unit may perform a fourth operation of monitoring whether the reformer and fuel cell unit of the system operate normally, a fifth operation of checking the reformer and fuel cell unit for performance degradation and abnormalities and checking whether water as the feed is supplied normally, and a sixth operation of establishing a plan for performance maintenance and system maintenance of the entire system by controlling parts where it is determined that any abnormality has occurred as a result of the checking.

According to some embodiments, the system may further comprise a sensing unit sensing the temperature of the burner of the reformer and a control unit enabling the temperature detected by the sensing unit to be maintained at a reference temperature. Based on the temperature detected by the sensing unit, the control unit 1) may control the amount of the off-gas stream being transferred to the burner of the reformer from the hydrogen separation unit, 2) may control the amount of an auxiliary fuel stream fed to the burner of the reformer through the auxiliary fuel inlet, or 3) may control the amount of the off-gas stream transported to the burner of the reformer from the hydrogen separation unit and control the amount of the auxiliary fuel stream fed to the burner of the reformer through the auxiliary fuel inlet.

According to some embodiments, the liquid-gas separation unit may comprise a demister.

According to some embodiments, the hydrogen separation unit may comprise a pressure swing adsorption (PSA) device.

According to some embodiments, the auxiliary fuel stream may comprise natural gas, a hydrogen-containing stream, the off-gas stream, or a combination thereof.

The present disclosure can provide a system for generating high-purity hydrogen and electricity. Since the system is equipped with the sensing unit and the control unit, the system can be efficiently operated.

### BRIEF DESCRIPTION OF THE DRAWINGS

FIG. 1 is a schematic of a system for generating electricity and hydrogen, according to one embodiment; and

FIG. 2 is a graph showing changes in system temperature measured by a sensing unit, according to one embodiment.

### DESCRIPTION OF THE INVENTION

The objects, advantages, and features of the present disclosure will become apparent from the following detailed description and preferred embodiments in conjunction with the accompanying drawings, but the disclosure is not necessarily limited thereto. Furthermore, in describing the preferred embodiment of the present disclosure, detailed description of the related art is omitted if it is determined that such description would unnecessarily obscure the spirit of the present disclosure.

The singular form used in the present specification may be intended to also include a plural form, unless otherwise indicated in the context. As used herein, the singular form of “a”, “an”, and “the” include plural referents unless the context clearly states otherwise.

The numerical ranges used in the present specification includes all values within the range including the lower limit and the upper limit, increments logically derived in a form and spanning in a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms such as “comprise”, “include”, “contain”, “have”, “may be”, and “be provided with” mean that there is a characteristic or a constitutional element described in the specification, and as long as it is not particularly limited, a possibility of adding any one or two or more other characteristics or constitutional elements is not excluded in advance.

Hereinafter, the preferred embodiment of the present disclosure will be described in detail with reference to the accompanying drawings.

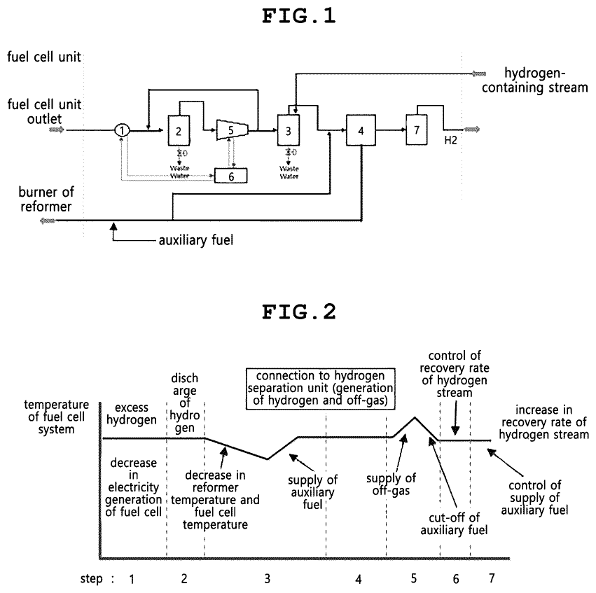

FIG. 1 is a schematic diagram of a system for generating electricity and hydrogen, according to one embodiment of the present disclosure.

In some embodiments of the present disclosure, there is provided a system for generating electricity and hydrogen. The system comprises a fuel cell unit that generates electricity and a fuel cell unit effluent stream comprising hydrogen, from a feed comprising natural gas and water. The fuel cell unit comprises a reformer comprising a burner. The fuel cell unit comprises a fuel cell unit inlet and a fuel cell unit outlet. The fuel cell unit reforms a feed comprising water and natural gas that contains alkanes such as methane and/or ethane when the feed is supplied through the fuel cell unit inlet. For example, the methane in the natural gas and the water can be reformed into carbon monoxide, carbon dioxide, and hydrogen by the reformer of the fuel cell unit by a series of the following reactions:

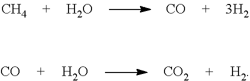

Since the reforming reactions are endothermic reactions, thermal energy is required for the reforming reactions. The reformer comprises the burner which provides thermal energy to be used in the reformer. Specifically, the burner generates thermal energy by burning fuel supplied from the outside or from other units of the system. For example, at an early stage of the operation of the system, the burner may receive natural gas from the outside and burn the natural gas to generate thermal energy.

The natural gas and water in the unreacted feed, along with the carbon monoxide, carbon dioxide, and water produced by the reformer, are fed to the fuel cell. The fuel cell supplied with the materials generates electricity through a series of reactions at the cathode and anode, depending on the type of fuel cell, as shown below, and produces water as a byproduct:

| | Phosphoric acid fuel cell | |
|---|---|---|
| | (PAFC) and Polymer | |
| Type of | Electrolyte Membrane | Solid Oxide Fuel |
| fuel cell | Fuel Cell(PEMFC) | Cell (SOFC) |
| Cathode | ½ O₂ + 2H⁺ + 2e⁻ −> H₂O | ½ O₂ + 2e⁻ −> O |
| Anode | H₂ −> 2H⁺ + 2e⁻ | H₂ + O⁼ −> H₂O + 2e⁻ |
| | | CO + O⁼ −> CO₂ + 2e⁻ |
| | | CH₄ + 4O⁼ => 2H2O + CO2 + 8e⁻ |

The electricity generated can be recovered and sold separately or supplied to electric vehicle charging stations.

In addition to water and hydrogen, the fuel cell unit effluent stream produced by the reforming reactions of the feed in the reformer may comprise unreacted natural gas of the feed, and carbon dioxide and carbon monoxide produced by the reforming of the natural gas in the reformer. Here, the water may be generated by the fuel cell unit and/or may be an unreacted portion of the water supplied as the feed for the reforming reactions. The fuel cell unit effluent stream is discharged to the outside from the fuel cell unit through the fuel cell unit outlet.

The system comprises a liquid-gas separation unit 2 that separates the fuel cell unit effluent stream into a liquid stream and a gas stream. In some embodiments, the liquid-gas separation unit 2 may have a liquid-gas separation unit inlet, a liquid outlet, and a gas outlet. The liquid-gas separation unit inlet is in fluid communication with the fuel cell unit outlet. Therefore, the fuel cell unit effluent stream exiting through the fuel cell unit outlet enters the liquid-gas separation unit through the liquid-gas separation unit inlet. The fuel cell unit effluent stream comprises a liquid component, such as water, and a gaseous component, such as hydrogen or unreacted natural gas, as described above. The fuel cell unit effluent stream is separated into a liquid stream and a gas stream by the liquid-gas separation unit. In some embodiments, the liquid stream may comprise water, the gas stream may comprise hydrogen, carbon monoxide, carbon dioxide, methane, or a combination thereof. In some embodiments, the gas stream may unavoidably comprise a trace amount (for example, less than 0.3 wt %) of gaseous water. There are no limitations on the way in which the liquid and gas streams are separated by the liquid-gas separation unit.

In some embodiments, the liquid-gas separation unit may comprise a demister. In some embodiments, the liquid-gas separation unit can comprise a demister having a structure of multiple layers of mesh-like fibers. In this case, when the fuel cell unit effluent stream comprising liquid and gaseous components is introduced into the liquid-gas separation unit through the inlet, the liquid stream can be separated from the gas stream by a density difference in a manner that only the gaseous component selectively can pass through the demister while the liquid component cannot pass through the demister and collides with the fibers of the demister, thereby being separated as droplets. The liquid stream and gas stream separated by the liquid-gas separation unit flow out of the liquid-gas separation unit through the liquid outlet and gas outlet, respectively. As described above, since there is no limitation on the method of separating the fuel cell unit effluent stream into the liquid stream and the gas stream in the liquid-gas separation unit, the liquid-gas separation unit may comprise any device capable of separating a feed stream into a liquid stream and a gas stream. For example, the liquid-gas separation unit may comprise a membrane separator in addition to the demister.

In some embodiments, the liquid-gas separation unit may further comprise an external stream inlet through which a hydrogen-containing stream supplied from outside the system is introduced. The hydrogen-containing stream refers to a stream that comprises at least hydrogen. That is, the hydrogen-containing stream may comprise other gaseous components and any liquid components as well as hydrogen. When the hydrogen-containing stream enters the liquid-gas separation unit, the liquid-gas separation unit separates the hydrogen-containing steam into a liquid stream and a gas stream. In the liquid-gas separation unit, the gas stream is separated into a hydrogen stream and an off-gas stream. That is, the liquid-gas separation unit can produce a hydrogen stream comprised of pure hydrogen from the hydrogen-containing stream which may comprise other gaseous and liquid components and liquid aside from hydrogen introduced through the external stream inlet. The hydrogen-containing stream is not limited in its origin as long as it comprises at least hydrogen. For example, the hydrogen-containing stream may be derived from a hydrogen refueling station.

The system comprises a hydrogen separation unit 4 that separates the gas stream into a hydrogen stream and an off-gas stream. In some embodiments, the hydrogen separation unit comprises a hydrogen separation unit inlet, a hydrogen outlet, and an off-gas outlet. The hydrogen separation unit inlet is in fluid communication with the gas outlet. A gas stream enters the hydrogen separation unit from the liquid-gas separation unit through the hydrogen separation unit inlet that is in fluid communication with the gas outlet. The hydrogen separation unit separates the incoming gas stream into a hydrogen stream and an off-gas stream, in which the off-gas stream comprises alkanes originating in the unreacted natural gas, gaseous components other than hydrogen such as carbon monoxide and carbon dioxide, and/or a certain amount of hydrogen. As described above, by separating the gas stream into a hydrogen stream and an off-gas stream, the hydrogen purity of the hydrogen stream can be increased. The way in which the hydrogen stream and the off-gas stream are produced by separation in the hydrogen separation unit is not particularly limited.

In some embodiments, the off-gas stream may comprise hydrogen. The hydrogen stream produced by the hydrogen separation unit may comprise unavoidable trace amounts (for example, less than 0.1 vol %) of the off-gas. The off-gas stream may comprise substantial amounts of hydrogen and can be used as fuel in the burner of the reformer. In some embodiments, the off-gas stream may comprise hydrogen in an amount of 10 to 50 vol %, or 15 to 45 vol %, or preferably 20 to 40 vol %. When the hydrogen content of the off-gas stream is less than 10 vol %, it is difficult for the burner of the reformer to generate sufficient thermal energy by combustion. When the hydrogen content of the off-gas stream is greater than 50 vol %, the hydrogen yield of the system may be unduly reduced.

In some embodiments, the hydrogen separation unit may comprise a pressure swing adsorption (PSA) device. The PSA device is a device that separates a specific component from a gas mixture under pressure using the molecular properties of the substance to be adsorbed and its affinity for the adsorbent. In some embodiments, the PSA device of the system comprises an adsorbent having an affinity for the off-gas, adsorbs the off-gas, excluding hydrogen, of the components contained in the gas stream in an adsorption mode at a pressure of about 5 to 15 bar, and desorbs and discharges the off-gas adsorbed by the adsorbent as an off-gas stream in a desorption mode at a pressure of about 1 bar or less.

In some embodiments, the hydrogen separation unit may comprise a membrane capable of separating a hydrogen stream from the off-gas stream.

The hydrogen stream produced by the hydrogen separation unit is discharged through the hydrogen outlet from the hydrogen separation unit, and the off-gas stream is discharged through the off-gas outlet from the hydrogen separation unit.

In the system, at least a portion of the off-gas stream is transported to the burner of the reformer. The off-gas outlet of the hydrogen separation unit is in fluid communication with the burner of the reformer, such that at least a portion of the off-gas stream discharged from the hydrogen separation unit can be transported to the burner of the reformer through the off-gas outlet. The burner serves to supply thermal energy to the reformer to promote the natural gas reforming reaction, which is an endothermic reaction, in the reformer, as described above, and the off-gas stream conveyed to the burner of the reformer can serve as a fuel for the combustion reaction in the burner of the reformer, thereby increasing the combustion efficiency of the burner of the reformer while ensuring that the flow rate in the burner of the reformer is sufficient for the transfer of thermal energy from the burner to the reformer. Furthermore, by transferring at least a portion of the off-gas stream to the burner of the reformer, the amount of exhaust gas emitted to the atmosphere can be reduced, which can have environmental benefits.

In some embodiments, at least a portion of the off-gas stream may be returned to the hydrogen separation unit. The hydrogen separation unit may separate the returned off-gas stream into a hydrogen stream and an off-gas stream, thereby maximizing the yield of hydrogen production.

In some embodiments, the burner of the reformer may further comprise an auxiliary fuel inlet through which an auxiliary fuel stream is supplied. The auxiliary fuel stream refers to a stream that supplies thermal energy to the burner of the reformer when the thermal energy that is supplied from the burner to the reformer is insufficient, to promote the feed reforming reaction in the reformer. As described above, the burner of the reformer generates thermal energy by combusting fuel such as natural gas, receives at least a portion of the off-gas stream from the hydrogen separation unit to maintain a flow rate necessary for thermal energy transfer to the reformer, and generates thermal energy using the off-gas stream as a fuel to provide thermal energy for the feed reforming reaction in the reformer. When the thermal energy provided by the burner of the reformer is insufficient to promote the feed reforming reaction in the reformer, an auxiliary fuel stream for supplying additional fuel or thermal energy may be supplied to the burner of the reformer. That is, an auxiliary fuel stream may be supplied to the burner of the reformer to ensure that the feed reforming reaction in the reformer is easily carried out. This makes the electricity and hydrogen generation yields in the system maintained above a certain level. The auxiliary fuel stream supplied to the burner of the reformer can be anything that can be burned as a fuel in the burner of the reformer to generate thermal energy so that the temperature of the burner of the reformer can be maintained at a predetermined level.

In some embodiments, the auxiliary fuel stream can comprise natural gas, a hydrogen-containing stream, an off-gas stream, or a combination thereof. All or any of these can be burned as fuel in the burner of the reformer to generate thermal energy, thereby providing the reformer with the thermal energy required for the reforming reaction. In some embodiments, the fuel cell unit may comprise a plurality of the fuel cell unit outlets and a plurality of the off-gas outlets. In this case, at least some of the fuel cell unit outlets and off-gas outlets may be in fluid communication with the auxiliary fuel inlet. With such a configuration, the streams from each unit of the system can be supplied to the burner of the reformer as a heat source for thermal energy generation or thermal energy maintenance.

In some embodiments, the system may further comprise a sensing unit and a control unit. The sensing unit may detect a water level in the liquid-gas separation unit or a temperature in the burner of the reformer and may transmit a signal indicating the detected water level or temperature detected by the sensing unit to the control unit. In some embodiments, the control unit may, based on the water level detected by the sensing unit, 1) control the amount of water serving as a feed, 2) check whether the reformer is operating normally, 3) check whether the fuel cell unit is operating normally, or 4) perform at least two items of items 1) to 3). Alternatively, in some embodiments, the control unit may, based on the temperature detected by the sensing unit, 1) control the amount of the off-gas stream transferred from the hydrogen separation unit to the burner of the reformer, 2) control the amount of the auxiliary fuel stream fed to the burner of the reformer through the auxiliary fuel inlet, or 3) control the amount of the off-gas stream transported to the burner of the reformer from the hydrogen separation unit and control the amount of the auxiliary fuel stream fed to the burner of the reformer through the auxiliary fuel inlet. In some embodiments, when the liquid-gas separation unit comprises a demister, the sensing unit may detect a level of water that collects in the liquid-gas separation unit by a mechanism that a liquid component fails to pass through the demister, collides with the fibers of the demister, and drops as droplets, and condenses in the liquid-gas separation unit. The sensing unit transmits a signal indicating the water level to the control unit when the detected water level is below a reference level or exceeds the reference level. In some embodiments, the sensing unit measures the water level in a certain section of the liquid-gas separation unit, in which the cumulative water level can be determined, and when the measured water level exceeds an upper limit set as the reference water level, the water in the liquid-gas separation unit is drained. In some embodiments, the sensing unit detects the temperature of the burner of the reformer. When the detected temperature is below the reference temperature or exceeds the reference temperature, a signal indicating the effect is transmitted to the control unit. As described above, the system is supplied with water as a feed, and the feed water is consumed during the reforming reaction in the reformer, and by-product water is generated at the anode side during the electricity generation reaction in the fuel cell unit. When the system is operating normally, the increase of water accumulated in the liquid-gas separation unit is constant. This means that the measured water level and the flow rate of the drained water are constant, or the time for which the water level rises from a lower reference water level to an upper reference water level is constant. An event in which the amount of water produced by the condensation is less than the lower limit of the reference water level range or an even in which the rate of water level change over time is lower than the normal rate means that the reformer and/or the fuel cell unit of the system are not operating normally. When such events occur, the control unit may control the amount of water supplied as a feed to make the system operate normally, and/or check whether the reformer is operating normally and/or check whether the fuel cell unit is operating normally. In some embodiments, the control unit may 1) monitor the operation status of the reformer and the fuel cell unit of the system, 2) check the reformer and the fuel cell for performance degradation and abnormalities and check the amount of water supplied as a feed for normal operation, and 3) establish a plan for performance maintenance and system maintenance of the entire system by controlling the units where any abnormality occurs on the basis of the results of the checking. In some embodiments, 1) when the detected water level is below a lower reference water level even though the yield of the hydrogen stream and the operating state of the fuel cell unit are normal, the control unit increases the amount of water input as a feed to the reformer by checking whether the feed water is supplied normally. On the other hand, 2) when the detected water level exceeds an upper reference water level even though the yield of the hydrogen stream and the operating state of the fuel cell are normal, the control unit decreases the amount of water input as a feed to the reformer by checking whether the water as a feed is normally supplied. In some embodiments, 3) when the yield of the hydrogen stream is low even though the operating condition of the fuel cell unit is normal and the detected water level is within the range of the reference water levels, the control unit may determine that the operating condition of the reformer is abnormal and check the performance of the reformer. After the checking, the control unit may issue an instruction for replacement of abnormal parts (for example, catalyst and/or device) of the reformer.

In some embodiments, when the system operates normally, thermal energy is transferred from the burner to the reformer to facilitate the reforming reaction in the reformer so that the temperature of the entire system can be maintained at a constant level. Therefore, the case where the system temperature exceeds or falls below a reference temperature means that the system is not operating normally. In this case, the control unit controls the system to operate normally.

FIG. 2 is a graph illustrating changes in temperature of the system according to temperature detection and control operations of the sensing unit and the control unit. Referring to FIG. 2, in step 3, when a decrease in the temperature of the system is detected by the sensing unit, the control unit causes the off-gas stream to be supplied to the burner of the reformer through the off-gas inlet so that thermal energy can be generated by the combustion operation of the burner of the reformer, and the system temperature can be increased to the reference temperature by the thermal energy possessed by the auxiliary fuel stream. By this operation, the system can maintain the normal operation. In some embodiments, on the other hand, in a condition in which the system temperature is higher than the reference temperature due to an oversupply of the off-gas stream, the control unit may operate to cut off the supply of the auxiliary fuel stream to the burner of the reformer, thereby preventing the burner of the reformer from generating additional thermal energy, which makes the system temperature return to the reference temperature (step 5).

In some embodiments, the sensing unit can be disposed at any position in the system. That is, there is no particular limitation on the position at which the sensing unit is installed. In some embodiments, given that the sensing unit detects the water level in the liquid-gas separation unit and/or the temperature of the burner of the reformer, the sensing unit may preferably be located within or adjacent to the liquid-gas separation unit and/or the burner of the reformer.

In some embodiments, the system may comprise two or more liquid-gas separation units 2 and 3 as shown in FIG. 1. With the inclusion of two or more liquid-gas separation units, the system can minimize the amount of unavoidable trace liquid components that may be present in the gas stream. The method in which the two or more liquid-gas separation units separate liquid and gas streams from each other is not particularly limited, and the respective separation methods performed by the two or more liquid-gas separation units may be the same or different from each other. Of the two or more liquid-gas separation units, a liquid-gas separation unit adjacent to the fuel cell unit has a liquid-gas separation unit inlet that is in fluid communication with the fuel cell unit outlet, a liquid outlet, and a gas outlet, and a second liquid-gas separation unit has a liquid-gas separation unit inlet that is in fluid communication with the gas outlet of the first liquid-gas separation unit adjacent thereto, a liquid outlet, and a gas outlet. The gas outlet of the liquid-gas separation unit adjacent to the hydrogen separation unit may be in fluid communication with the hydrogen separation unit inlet.

In some embodiments, the liquid content of the gas stream may be less than 5 wt %. When the hydrogen separation unit to which the gas stream is supplied is a PSA device, the hydrogen separation unit can separate the target component to be separated from the gas stream by adsorbing the other gaseous components. When an adsorbent is used in the adsorption process, and the liquid content of the gas stream is higher than 5 wt %, the adsorption capacity of the adsorbent may be reduced with the progress of the adsorption due to the excessively high liquid content. In this case, it may be difficult to obtain a high purity hydrogen stream. In some embodiments, the liquid content of the gas stream may preferably be less than 3 wt % and more preferably less than 1 wt %.

In some embodiments, the system may further comprise a compressor 5. The compressor may compress the gas stream to be supplied to the hydrogen separation unit so that the gas stream supplied to the hydrogen separation unit can satisfy the required pressure conditions of the adsorption mode in one embodiment in which the hydrogen separation unit is a PSA device.

In some embodiments, the system may further comprise a heat exchanger 1. Since the fuel cell unit effluent stream is hot enough to remain in a gaseous state, the water contained in the effluent stream exists in a gaseous state. The heat exchanger 1 lowers the temperature of the fuel cell unit effluent stream to condense water vapor to water (i.e., liquid state), allowing the water to be separated as a liquid stream by the liquid-gas separation unit. That is, the heat exchanger 1 minimizes the water content of the gas stream output from the liquid-gas separation unit, thereby preventing damage to the compressor.

In some embodiments, the system may further comprise a chiller 6. The chiller 6 may lower the temperature of the gas stream, which has been raised in temperature during the compression process in the compressor, and further remove water present in a gaseous state in the gas stream by condensing the gas stream.

In some embodiments, the system may further comprise one or more buffer tanks 7. Referring to FIG. 1, one or more buffer tanks 7 may serve to store the hydrogen stream exiting the hydrogen separation unit and to supply the stored hydrogen stream to other systems or devices requiring high purity hydrogen.

In some embodiments, the hydrogen stream may have a hydrogen purity of 99.9% or greater. In conclusion, with the inclusion of each of the units described above, the system has the advantage of simultaneously generating electricity and ultra-high purity hydrogen from a feed comprising natural gas and water.

Embodiments of the present disclosure has been described in detail with reference to the accompanying drawings. The embodiments are presented only for illustrative purposes and are not intended to restrict the scope of the present disclosure. It will be apparent that modifications and improvements can be made without departing from the technical ideas of the present disclosure by the ordinarily skilled in the art.

All mere alterations or modifications of the present disclosure fall within the scope of the present disclosure, the specific scope of protection of which will be made clearly defined by the appended claims.

### DESCRIPTION OF SYMBOLS

1: heat exchanger
2: first liquid-gas separation unit
3: second liquid-gas separation unit
4: hydrogen separation unit
5: compressor
6: chiller
7: buffer tank

What is claimed is:

1. A system for generating electricity and hydrogen, the system comprising:
a fuel cell unit generating electricity and a fuel cell unit effluent stream comprising hydrogen from a feed comprising natural gas and water, the fuel cell unit comprising a reformer comprising a burner;
a liquid-gas separation unit separating the fuel cell unit effluent stream into a liquid stream and a gas stream; and
a hydrogen separation unit separating the gas stream into a hydrogen stream and an off-gas stream,
wherein at least a portion of the off-gas stream is transferred to the burner of the reformer.

2. The system of claim 1, wherein the burner of the reformer comprises an auxiliary fuel inlet through which an auxiliary fuel stream is supplied.

3. The system of claim 2, wherein the liquid-gas separation unit comprises an external stream inlet through which a hydrogen-containing stream is externally introduced into the system.

4. The system of claim 3, further comprising:
a sensing unit detecting a water level in the liquid-gas separation unit; and
a control unit performing control such that the water level detected by the sensing unit is maintained at a reference level,
wherein based on the water level detected by the sensing unit, the control unit performs a first operation of controlling an amount of water supplied as the feed, a second operation of checking whether the reformer is operating normally, a third operation of checking whether the fuel cell is operating normally, or at least two of the first through third operations.

5. The system of claim 4, wherein according to a yield of the hydrogen stream output from the hydrogen separation unit and a signal output from the sensing unit, the signal indicating the water level or a rate of change of the water level in the liquid-gas separation unit, the control unit performs a fourth operation of monitoring operation statuses of the reformer and fuel cell unit of the system, a fifth operation of checking the reformer and the fuel cell for performance degradation and abnormalities and of checking whether supply of the water as the feed is normal, and a sixth operation of establishing a plan for performance maintenance and system maintenance of the entire system by controlling parts where it is determined that any abnormality has occurred as a result of the checking.

6. The system of claim 3, further comprising:
a sensing unit detecting a temperature of the burner of the reformer; and
a control unit performing control for maintaining the temperature detected by the sensing unit at a reference temperature,
wherein based on the temperature detected by the sensing unit, the control unit controls an amount of the off-gas stream transported to the burner of the reformer from the hydrogen separation unit, controls an amount of the auxiliary fuel stream fed to the burner of the reformer through the auxiliary fuel inlet, or controls an amount of the off-gas stream transported to the burner of the reformer from the hydrogen separation unit and controls an amount of auxiliary fuel stream fed to the burner of the reformer through the auxiliary fuel inlet.

7. The system of claim 1, wherein the liquid-gas separation unit comprises a demister.

8. The system of claim 1, wherein the hydrogen separation unit is a pressure swing adsorption (PSA) device.

9. The system of claim 2, wherein the auxiliary fuel stream comprises natural gas, a hydrogen-containing stream, the off-gas stream, or a combination thereof.
